(19) United States
(12) Patent Application Publication
(10) Pub. No.: US 2015/0093272 A1
(43) Pub. Date: Apr. 2, 2015

(54) ELECTRICALLY DRIVEN AIRCRAFT

(71) Applicant: Siemens Aktiengesellschaft, Manchen (DE)

(72) Inventors: Olaf Kömer, Nurnberg (DE); Thomas Lange, Furth (DE); Korbinian Petermaier, Munchen (DE); Marco Schramm, Nurnberg (DE)

(21) Appl. No.: 14/500,216

(22) Filed: Sep. 29, 2014

(30) Foreign Application Priority Data
Sep. 30, 2013 (DE) 10 2013 219 724.1

(51) Int. Cl. B64D 27/24; B64C 11/44; B64C 11/30; B64C 11/38; B64D 35/02; B64C 11/00

(52) U.S. Cl. CPC B64D 27/24; B64D 35/02; B64C 11/00; B64C 11/30; B64C 11/38; B64C 11/44
USPC 417/423.1

(57) ABSTRACT

An electrically driven aircraft includes at least one drive arrangement which has an aircraft propeller comprising a propeller shaft, a propeller bearing configured to radially and axially support the propeller shaft, a propeller hub which is driven by the propeller shaft, and a plurality of propeller blades attached to the propeller hub. A dynamoelectric rotary machine has a stator and a rotor which interacts with the stator and is coupled directly to the propeller shaft. The propeller bearing and the stator, are accommodated in a support structure which is mechanically coupled to an aircraft structure of the aircraft.

### CROSS-REFERENCES TO RELATED APPLICATIONS

This application claims the priority of German Patent Application, Serial No. 102013219724.1, filed Sep. 30, 2013, pursuant to 35 U.S.C. 119(a)-(d), the disclosure of which is incorporated herein by reference in its entirety as if fully set forth herein.

### BACKGROUND OF THE INVENTION

The present invention relates to an electrically driven aircraft.

The following discussion of related art is provided to assist the reader in understanding the advantages of the invention, and is not to be construed as an admission that this related art is prior art to this invention.

Aircraft with propeller drives are normally driven by internal combustion engines, electric machines or hybrid combinations of the two. In the case of electrically driven propellers a distinction is made between gear units and direct drives. Due to the absence of a transmission drive, direct drives are less complex and therefore more reliable, and the entire drive train is more efficient.

Propellers and electric machines each have a separate mount with their necessary degrees of freedom. The electric machine is normally connected on the rotor side by way of a coupling to the propeller shaft and on the stator side to the aircraft structure. The mount of the propeller is designed such that it absorbs the axial pulling forces required for the necessary thrust and supports these on the aircraft structure. The motor mount is in this case decoupled in the axial direction. In addition, besides axial forces, gyroscopic torques and radial bending torques or forces must be taken into consideration.

The presence of additional radial bearing points of the electric motor here represent a redundant mechanical dimensioning of the drive axle, so that the coupling between propeller and motor shaft must be designed to be correspondingly flexible.

It would therefore be desirable and advantageous to provide an improved electrically driven aircraft which obviates prior art shortcomings and which has a drive which is compact and reliable in operation.

### SUMMARY OF THE INVENTION

According to one aspect of the present invention, an electrically driven aircraft, includes at least one drive arrangement which has
an aircraft propeller comprising a propeller shaft, a propeller bearing configured to radially and axially support the propeller shaft, a propeller hub which is driven by the propeller shaft, and a plurality of propeller blades attached to the propeller hub,
a dynamoelectric rotary machine having a stator and a rotor interacting with the stator and coupled directly to the propeller shaft, and
a support structure configured to accommodate the propeller bearing and the stator, said support structure being mechanically coupled to an aircraft structure of the aircraft.

In accordance with the present invention, the electric rotary machine can be designed without bearings, so that the mount of the propeller additionally takes over the active part components of the electric machine. The rotor of the electric machine is attached directly to the propeller shaft in a rotatably fixed manner, the stator of the electric machine being mechanically connected to the one suspension of the propeller, i.e. to the support structure. Thus a flexible coupling between the shaft of the propeller and the shaft of the motor can now be dispensed with, thereby in particular also reducing demands on the mechanical tolerances of the shaft.

According to the invention, the mount of the propeller can be designed such that additionally registered loads of the rotor are also absorbed. Furthermore, it is particularly advantageous when the additional weight of the rotor is as small as possible and when its axial extent and the distance from the mount is small in relation to the support width of the mount of the propeller.

The electric rotary machine can have an output of 80 to 1000 kW. The electric rotary machine advantageously has a compact external diameter which is between 150 mm and 1000 mm. The external diameter relates in particular to an active part of the electric rotary machine.

The electric rotary machine can also be implemented as an axial flux machine or as a transverse flux machine. Advantageously the active parts of the rotor are in this case positioned on a star carrier which carries the torque onto the shaft of the propeller without itself having a large moment of inertia or large dimensions.

The electrically driven aircraft can have a plurality of electric rotary machines arranged axially in series one behind the other. The plurality of machines are coupled directly to the propeller shaft. Although in this arrangement the axial extent increases, the overall height can be reduced when electric rotary machines with a smaller external diameter are used, which may be advantageous for the aerodynamic behavior. The inertial behavior of the machine could also improve.

According to another advantageous feature of the present invention, the rotor can be configured as an external or internal rotor. The invention can be applied both to internal rotor machines and to external rotor machines, since ultimately the mount is taken over completely from the mount of the propeller. It should merely be ensured that the weight of the rotor is kept as small as possible, and the axial extents, in particular the distance from the mount, are kept small in relation to the support width of the propeller mount.

According to another advantageous feature of the present invention, the setting angle of the propeller blades can be adjusted hydraulically or electrically in relation to the air flow. In this way, a particularly efficient drive operation is attained. A hydraulic adjustment of the propeller blades can be realized via a hydraulic pump and a governor which builds up a hydraulic overpressure, which in turn actuates an adjustment mechanism in the propeller hub. Oil in this hydraulic circuit is advantageously also used for the mount of the propeller shaft. To this end in particular only one circuit is used for the oil.

According to another advantageous feature of the present invention, the support structure can have a funnel-shaped configuration with a cross-sectional area which increases in a direction away from the propeller blades. This results in a particularly streamlined support structure of the entire drive arrangement. The cross-sectional area of the support structure of the drive arrangement is thus comparatively small in particular in a vicinity of the propeller and extends rearward, i.e. at a greater distance from the propeller. This in particular has the advantage that the electric machine can be arranged where the cross-sectional area of the support structure is expanded, and because of the expanded cross-sectional area corresponding torques can be provided by the electric machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic front view of an aircraft, having incorporated therein the subject matter of the present invention; and

FIG. 2 is a schematic longitudinal section of a drive arrangement in accordance with the present invention for use in the aircraft.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

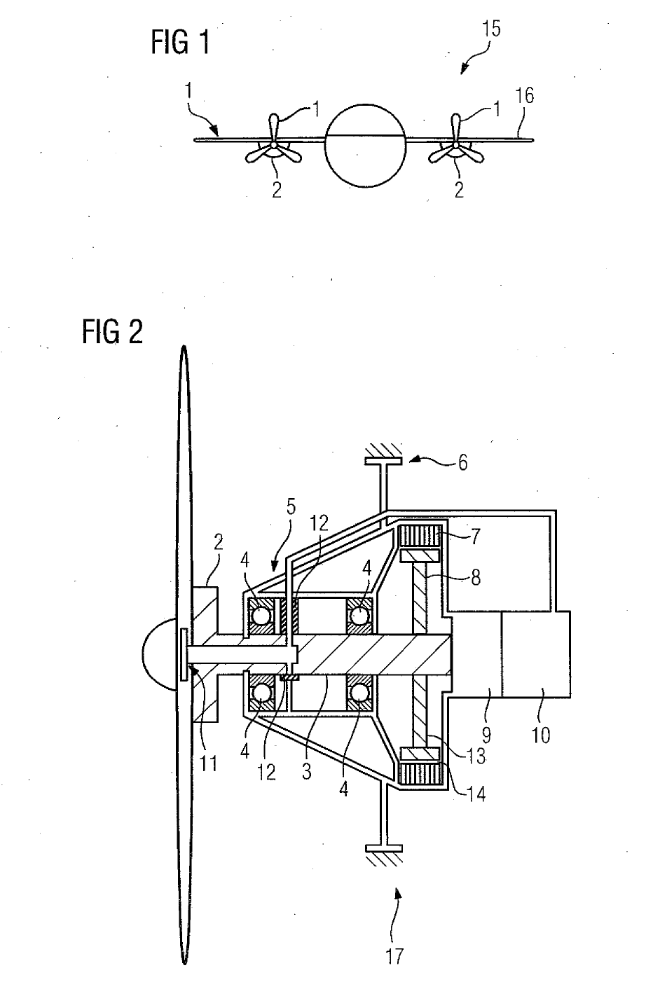

Turning now to the drawing, and in particular to FIG. 1, there is shown an outline view of an aircraft 15 which has a drive arrangement 17 on each of its support surfaces 16. This drive arrangement 17 has propellers which are used for propulsion and which are driven by way of an electric machine.

FIG. 2 shows the drive arrangement 17 in an outline longitudinal section. The aircraft propeller has a plurality of propeller blades 1 which are combined in one propeller hub 2. The adjustment mechanism 11 is arranged in the propeller hub 2 and results in the angular adjustment of the propeller blades. The propeller hub 2 is set in rotation by a propeller shaft 3, the propeller shaft 3 being connected directly to a rotor 8 of a dynamoelectric rotary machine. A stator 7 of the dynamoelectric machine is radially joined to the rotor 8 and is separated from the rotor 8 by an air gap 14. Besides a radial flux machine, an axial flux machine or a transverse flux machine—TF machine—can also be used, but is not explicitly depicted.

When a winding system of the stator 7, not shown in greater detail, is energized, this rotor 8 and the propeller shaft 3 connected thereto rotates as a result of electromagnetic interaction with, for example, permanent magnets of the rotor 8. Therefore the propeller is set in rotation and drive is provided to the aircraft 15.

Advantageously now both the mount of the propeller shaft and the mount of the rotor 8 are combined in one bearing arrangement. These bearings 4 absorb both the radial and the axial forces during operation of the drive arrangement 17.

Advantageously therefore no separate mount for the motor or for a propeller shaft is now necessary, so that the entire drive arrangement can be made significantly more compact. The support structure 5 which holds both the bearing arrangement and the stator 7 is in turn supported in the aircraft structure 6. To generate a corresponding torque, the rotor 8 has a comparatively large diameter. The active parts of the rotor 8 are in this case arranged on the outer circumference, so that the active parts of the rotor 8 are held by a star carrier 13 which is connected to the propeller shaft in a rotatably fixed manner. This star carrier 13 is designed to be comparatively light for reasons of inertia and mass. This is achieved by using corresponding materials or else by cutouts for example from a disk.

In order now to adjust the propeller blades 1 of the propeller, a hydraulic adjustment mechanism is actuated in the propeller hub 2 by way of a hydraulic pump 9 and a governor 10 providing the overpressure. By way of hydraulic lines running in the region of the bearing 4, a leaky seal 12, in particular technically conditioned, can simultaneously provide cooling and lubrication to the mount.

It is particularly advantageous, but not depicted in greater detail, if all the actuation lines and hydraulic lines run inside a hollow propeller shaft. This makes the whole drive arrangement 17 even more compact.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electrically driven aircraft, comprising at least one drive arrangement which includes:
an aircraft propeller comprising a propeller shaft, a propeller bearing configured to radially and axially support the propeller shaft, a propeller hub which is driven by the propeller shaft, and a plurality of propeller blades attached to the propeller hub,
a dynamoelectric rotary machine having a stator and a rotor interacting with the stator and coupled directly to the propeller shaft, and
a support structure configured to accommodate the propeller bearing and the stator, said support structure being mechanically coupled to an aircraft structure of the aircraft.

2. The electrically driven aircraft of claim 1, wherein the rotor is configured as an external or internal rotor.

3. The electrically driven aircraft of claim 1, wherein the propeller blades are each defined by a setting angle which is adjustable by a hydraulic mechanism or an electric mechanism.

4. The electrically driven aircraft of claim 3, wherein the hydraulic mechanism includes a hydraulic pump operatively connected to the propeller shaft and a governor operatively connected to the hydraulic pump.

5. The electrically driven aircraft of claim 4, wherein the propeller shaft is configured in the form of a hollow shaft.

6. The electrically driven aircraft of claim 1, wherein the support structure has a funnel-shaped configuration with a cross-sectional area which increases in a direction away from the propeller blades.
